(19) United States
(12) Patent Application Publication
(10) Pub. No.: US 2014/0177825 A1
(43) Pub. Date: Jun. 26, 2014

(54) Asymmetric Tokenization

(71) Applicant: Protegrity Corporation, George Town (KY)

(72) Inventors: Ulf Mattsson, Cos Cob, CT (US); Yigal Rozenberg, Wilton, CT (US)

(73) Assignee: Protegrity Corporation, George Town (KY)

(21) Appl. No.: 14/107,202

(22) Filed: Dec. 16, 2013

Related U.S. Application Data
(60) Provisional application No. 61/740,017, filed on Dec. 20, 2012.

(51) Int. Cl. H04L 9/14

(52) U.S. Cl. CPC H04L 9/14
USPC 380/28

(57) ABSTRACT

An asymmetric encoding environment includes a plurality of secure computer systems, each configured to perform one or more encoding operations on received data using one or more encoding components inaccessible to the other secure computer systems. A first secure computer system receives sensitive data and tokenizes the sensitive data using a first token table inaccessible to a second secure computer system to produce first tokenized data. The second secure computer system receives the first tokenized data and tokenizes the sensitive data using a second token table inaccessible to the first secure computer system to produce second tokenized data. The second secure computer system can store the second tokenized data for subsequent access. The first and second secure computer systems can perform additional data protection techniques, such as encryption and data modification using initialization vectors. In such embodiments, each secure computer system uses an encryption key and/or initialization vector inaccessible to the other secure computer system.

### FIELD OF ART

This application relates to the field of data protection, and more specifically to the protection of information using tokenization.

### BACKGROUND

Many websites, services, and applications implement data protection techniques. Certain techniques involve the use of an encryption key or password that can be subject to interception or brute force guessing. Other methods may protect data but require extensive computing resources to encode and decode data. Given the potential weakness of certain data protection techniques, systems that implement such techniques may be vulnerable to a breach by an unauthorized entity. Thus, it may be advantageous to implement one or more different data protections techniques at each of a plurality of different data protection systems, such that no one system can fully encode or decode sensitive data.

### SUMMARY

To improve data security, data protection techniques can be performed in an asymmetric encoding environment by two or more communicatively coupled but physically separated secure computer systems. Each secure computer system can perform one or more encoding operations, such as tokenization operations, encryption operations, data modifications (for instance, using initialization vectors), and the like. Each secure computer system encodes data using one or more encoding components (such as token tables, encryption keys, initialization vectors, and the like) that are inaccessible to the other secure computer systems. Encoding the data makes it opaque to any other system that does not have access to the encoding components. For example, a first secure computer system can tokenize sensitive data with a first token table to produce first tokenized data, and a second secure computer system can tokenize the first tokenized data with a second token table to produce and store the second tokenized data. In this example, the first secure computer system cannot access the second token table, and the second secure computer system cannot access the first token table.

Secure computer systems of the asymmetric encoding environment can also decode encoded data. Continuing with the previous example, the second secure computer system can detokenize the second tokenized data using the second token table to produce first detokenized data, and a third secure computer system can detokenize the first detokenized data using the first token table to produce the original sensitive data. In some embodiments, secure computer systems in the asymmetric encoding environment encrypt data using public-private encryption key pairs. Continuing further with the previous example, the third secure computer system can generate a public-private encryption key pair, and can provide the public key to the first secure computer system. When encoding data, the first secure computer system can encrypt the sensitive data using the public key (for instance, either before or after tokenizing the sensitive data), and when decoding data, the third secure computer system can decrypt the data using the private key.

By preventing each secure computer system from having access to all encoding components used in encoding or decoding data, the asymmetric encoding environment beneficially increases security by preventing a security compromise of any one secure computer system from compromising the entire encoding environment. For example, if an unauthorized entity accesses a first token table stored at a first secure computer system, the unauthorized entity would be unable to fully encode or decode sensitive data using the first token table without also having access to a second token table used by a second secure computer system to further encode the sensitive data.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a system diagram for an asymmetric encoding environment, according to one embodiment.

FIG. 2 illustrates data flow in an asymmetric encoding environment, according to one embodiment.

FIG. 3 illustrates a first example chained asymmetric encoding operation, according to one embodiment.

FIG. 4 illustrates a second example chained asymmetric encoding operation, according to one embodiment.

FIG. 5 illustrates a third example chained asymmetric encoding operation, according to one embodiment.

FIG. 6 illustrates data flow in an asymmetric encoding environment, according to one embodiment.

FIG. 7 illustrates a process for encoding data using asymmetric encoding, according to one embodiment.

The figures (Figs.) depict embodiments for purposes of illustration only. One skilled in the art will readily recognize from the following description that alternative embodiments of the structures and methods illustrated herein can be employed without departing from the principles of the invention described herein.

### DETAILED DESCRIPTION

Reference will now be made in detail to several embodiments, examples of which are illustrated in the accompanying figures. It is noted that wherever practicable, similar or like reference numbers can be used in the figures and can indicate similar or like functionality. The figures depict embodiments of the disclosed system (or method) for purposes of illustration only. One skilled in the art will readily recognize from the following description that alternative embodiments of the structures and methods illustrated herein can be employed without departing from the principles described herein.

### Tokenization Overview

The transmission and storage of sensitive data, such as passwords, credit card numbers, social security numbers, bank account numbers, driving license numbers, medical records, employment information, education records, transaction information, date information, etc., can be challenging. Before sensitive data can be transmitted or stored, the sensitive data can be tokenized into tokenized data to prevent an unauthorized entity from accessing the data.

As used herein, the tokenization of data refers to the generation of tokenized data by querying one or more token tables mapping input values to tokens with the one or more portions of the data, and replacing the queried portions of the data with the resulting tokens from the token tables. Tokenization can be combined with encryption for increased security, for example by encrypting sensitive data using a mathematically reversible cryptographic function (e.g., datatype-preserving encryption or DTP), an asymmetric cryptographic function (e.g., public key cryptography), or a similar encryption before or after the tokenization of the sensitive data. Any suitable type of encryption can be used in the tokenization of data. A detailed explanation of the tokenization process can be found in U.S. patent application Ser. No. 13/595,438, filed Aug. 27, 2012, which is hereby incorporated by reference.

As used herein, the term token refers to a string of characters mapped to an input string of characters in a token table, used as a substitute for the string of characters in the creation of tokenized data. A token can have the same number of characters as the string being replaced, or can have a different number of characters. Further, the token can have characters of the same type (such as numeric, symbolic, or alphanumeric characters) as the string of characters being replaced or characters of a different type.

Any type of tokenization can be used to perform the functionalities described herein. One such type of tokenization is static lookup table (“SLT”) tokenization. SLT tokenization maps each possible input value (e.g., possible character combinations of a string of characters) to a particular token. One embodiment of an SLT includes a first column comprising permutations of input string values, and can include every possible input string value. A second column of the SLT includes tokens, with each associated with an input string value of the first column. Each token in the second column can be unique among the tokens in the second column. Optionally, the SLT can also include one or several additional columns with additional tokens mapped to the input string values of the first column, for example for use in subsequent tokenization operations. Other data structures may be used for an SLT as well, such as a tie, B-tree, hash table, or the like.

In some embodiments, to increase the security of tokenization, sensitive data can be tokenized two or more times using the same or additional token tables. This process is referred to as tokenization “chaining” For example, the first 8 digits of a 16 digit credit card number can be tokenized with an 8 digit token table to form first tokenized data, and the last 12 digits of the first tokenized data can be tokenized using a 12 digit token table to form second tokenized data. In another example, the first 4 digits of a credit card number are tokenized using a first token table, the second 4 digits are tokenized with a second token table, the third 4 digits are tokenized with a third token table, and the last 4 digits are tokenized with a fourth token table. Certain sections of the sensitive data can also be left un-tokenized; thus a first subset of the resulting tokenized data can contain portions of the sensitive data and a second subset of the tokenized data can contain a tokenized version of the sensitive data. It should be noted that as used herein, “chained encoding” refers to the performance of sequential tokenization operations, encryption operations, data modifications, or other data protection operations.

Dynamic token lookup table (“DLT”) tokenization operates similarly to SLT tokenization, but instead of using static tables for multiple tokenizations, a new token value is generated and included in a token table entry each time sensitive data is tokenized. The new token value can be generated randomly, can be randomly selected from among a set of values, or can be generated via any other suitable means. A seed value can be used to generate token values, to select a set of values from which to select a token value from among multiple sets of values, or to randomly select a value from among a set of values for use as the token value. It should be noted that as used herein, “randomly” can refer to pseudo-randomly or substantially randomly. The seed value can include a portion of data being tokenized.

The security of tokenization can be further increased through the use of initialization vectors (“IVs”). An initialization vector is a string of data used to modify sensitive data prior to tokenizing the sensitive data. Example sensitive data modification operations include performing linear or modulus addition on the IV and the sensitive data, performing logical operations on the sensitive data with the IV, encrypting the sensitive data using the IV as an encryption key, and the like. The IV can be a portion of the sensitive data. For example, for a 12-digit number, the last 4 digits can be used as an IV to modify the first 8 digits before tokenization. IVs can also be retrieved from an IV table, received from an external entity configured to provide IVs for use in tokenization, or can be generated based on, for instance, the identity of a user, the date/time of a requested tokenization operation, based on various tokenization parameters, and the like. Data modified by one or more IVs that is subsequently tokenized includes an extra layer of security—an unauthorized party that gains access to the token tables used to tokenized the modified data will be able to detokenize the tokenized data, but will be unable to de-modify the modified data without access to the IVs used to modify the data.

The detokenization of data refers to an operation performed to convert tokenized data into the data on which tokenization was performed. To detokenize data, the tokenized data is used to query the one or more token tables used to tokenize the data. For instance, if a 4-digit number is tokenized by querying a token table to identify a token mapped to the 4-digit number, and the identified token is used to replace the 4-digit number to form tokenized data, then the tokenized data can be detokenized by querying the token table with the token to identify the 4-digit number mapped to the token, and the 4-digit number can be used to replace the token to form detokenized data. Similarly, in order to detokenize data, any vector modifications performed during the course of the tokenization must be reversed. For instance, if a 4-digit number is modified by a 4-digit vector using modulo addition prior to tokenization, then to detokenize the tokenized data, modulo subtraction using the 4-digit vector must be performed after detokenization.

### Tokenization System Overview

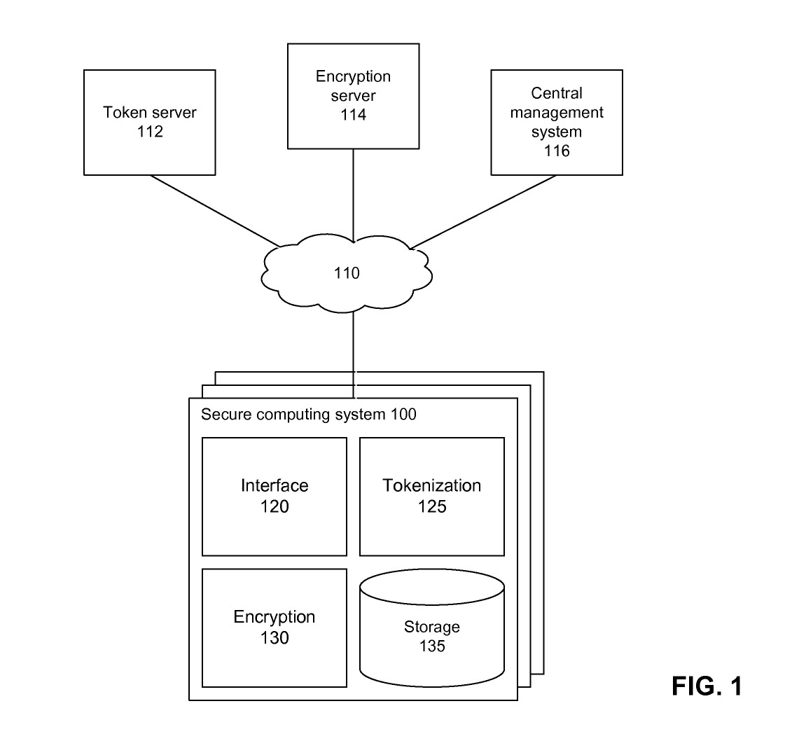

FIG. 1 is a system diagram for an asymmetric encoding environment, according to one embodiment. The environment of FIG. 1 includes one or more secure computer systems 100, a token server 112, and encryption server 114, and a central management system 116, communicatively coupled via a network 110. Each of the secure computer systems can be associated with a retailer, business, financial institution or other organization, though it should be noted that the secure computer systems can also be associated with individual users or any other suitable entity. A secure computer system can receive sensitive data, for instance a credit card number or other account number during the course of a transaction with a user, and can encode the sensitive data using one or more data protection techniques, such as tokenization, encryption, and the like. Similarly, each secure computer system can receive data previously encoded by other secure computer systems, and can further encode the received data using additional data protection techniques prior to storing the further encoded data. The secure computer systems can be physically separated, for instance located in different server racks, data centers, buildings, locations, cities, networks, and the like. It should be noted that in other embodiments, the environment of FIG. 1 includes additional or different components.

It should be noted that each secure computer system 100 performs encoding operations and has access to various encoding components (such as token tables, encryption keys, and the like) used in the encoding operations. A secure computer system is a computer that, once configured to perform the encoding operations described herein, is a specialized computer and is no longer a general purpose computer. The encoding operations described herein are necessarily performed by machines, and cannot be performed with the human mind alone.

Each of the modules of FIG. 1 can be computing devices capable of processing data as well as transmitting data to and receiving data from the other modules of FIG. 1 via the network 110. For example, the secure computer systems 100, the token server 112, the encryption server 114, and the central management system 116 can include a desktop computer, laptop computer, smart phone, tablet computing device, server, payment terminal, or any other device having computing and data communication capabilities. Each computing device includes one or more processors, memory, storage, and networking components. The modules of FIG. 1 are coupled to the network and can interact with other modules coupled to the network using software such as a web browser or other application with communication functionality. Such software can include an interface for communicating with the other modules via the network.

The network 110 connecting the various modules is typically the Internet, but can be any network, including but not limited to a local area network (LAN), metropolitan area network (MAN), wide area network (WAN), cellular network, wired network, wireless network, private network, virtual private network (VPN), direct communication line, and the like. The network can also be a combination of multiple different networks.

As noted above, each secure computer system 100 is configured to receive data and to encode the received data using one or more data protection techniques such as, for example, tokenization and encryption. In some embodiments, a secure computer system receives raw sensitive data to be encoded, and in other embodiments, a secure computer system receives previously encoded data to be further encoded. For instance, a first secure computer system may be a payment terminal and the received sensitive data may be a credit card number. Continuing with this example, the payment terminal can encode the credit card number producing a first encoded credit card number, and can output the first encoded credit card number to a second secure computer system, such as a bank server. The bank server can further encode the first encoded credit card number producing a second encoded credit card number, and can store the second encoded credit card number. Accordingly, the environment of FIG. 1 can be used in the receiving, protection, and transmission of financial information, though it should be emphasized that information other than financial information can be similarly processed.

Each secure computer system 100 includes an interface module 120, a tokenization module 125, an encryption module 130, and a storage module 135. In other embodiments, secure computer systems include components other than those illustrated in FIG. 1. The interface module is configured to provide an interface between entities external to the secure computer system and modules within the secure computer system. The interface module can provide a graphic user interface (GUI), for instance via a secure computer system display, and/or can provide a communicative interface, for instance configured to automatically route received sensitive data, token tables, encryption keys, and the like to modules within the secure computer system. The interface module can also provide an interface for communications between modules of the secure computer system, for instance by storing received token tables and encryption keys in the storage module 135. The interface module can also receive requests for encoded data, for instance from other secure computer systems or from an external entity not shown in FIG. 1, and can provide encoded data to the requesting entity in response.

The tokenization module 125 is configured to tokenize all or part of received data using one or more tokens. In the embodiments described herein, the tokenization module performs SLT tokenization, though it should be noted that other forms of tokenization can also be performed according to the principles described herein. The tokenization module can generate token tables for use in tokenizing data, or can request and receive, via the interface module 120, token tables from the token server 112. Token tables received from the token server can be stored in the storage module 135. The tokenization module can perform one or more chained tokenization iterations, and can implement various types of data modifications before or after each tokenization iteration. For instance, the tokenization module can modify received data using an initialization vector, and can tokenize the modified data. The tokenization module, after tokenizing data, can store the tokenized data in the data storage module, can provide the tokenized data to the encryption module 130 for encryption, or can transmit the tokenized data to another secure computer system or an entity not shown in FIG. 1.

The encryption module 130 is configured to encrypt all or part of received data using one or more encryption algorithms and/or one or more encryption keys. In the embodiments described herein, the encryption module performs public-private key encryption, though it should be noted that other forms of encryption can also be performed according to the principles described herein. The encryption module can generate an encryption key for use in encrypting data, or can request and receive, via the interface module 120, encryption keys from the encryption server 114. Encryption keys received from the encryption server can be stored in the storage module 135. The encryption module can perform one or more chained encryption iterations (for instance, encrypting data in a first encryption operation, and encrypting the encrypted data in a second encryption operation). The encryption module can also perform one or more data modifications before or after each encryption iteration, for instance using initialization vectors. The encryption module, after encrypting data, can store the encrypted data in the data storage module, can provide the encrypted data to the tokenization module 125 for tokenization, or can transmit the encrypted data to another secure computer system or an entity not shown in FIG. 1.

It should be noted that although encryption and tokenization are described as performed by separate modules herein, one module can perform both types of encoding. In addition, data can be encoded using any combination or order of tokenization operations, encryption operations, or any other data protection techniques. For instance, received data can be tokenized in a first tokenization operation, the tokenized data can be encrypted, and the encrypted data can be tokenized in a second tokenization operation. Thus, a secure computer system 100 can perform one or more chained encoding iterations on received data, and can provide the encoded data to a second secure computer system that can perform one or more additional chained encoding iterations on the encoded data.

The token server 112 is configured to provide token tables to secure computer systems 100, for instance upon request or periodically. The encryption server 114 is configured to provide encryption keys and/or encryption algorithms to secure computer systems, upon request, periodically, and the like. The central management system 116 is configured to manage the performance of chained encoding and decoding operations across multiple secure computer systems, the transmission of data between secure computer systems, and distribution of token tables and encryption keys between secure computer systems. The central management system is discussed in greater detail below.

### Asymmetric Encoding

Asymmetric tokenization can improve the security of various data protection techniques by distributing encoding operations (e.g., encryption, tokenization, data modification, and the like) and decoding operations (e.g., decryption, de-tokenization, de-modification, and the like) across physically separate secure computer systems. As used herein, “asymmetric encoding” refers to the distribution of chained encoding operations over two or more physically separate secure computer systems such that no one secure computer system can completely encode data. Similarly, “asymmetric decoding” refers to the distribution of chained decoding operations over two or more secure computer systems such that no one secure computer system can completely decode data. It should be noted that in some instances herein reference is made herein to asymmetric encoding for the purposes of simplicity, but that the principles described herein also apply to asymmetric decoding.

In asymmetric encoding, sensitive data is accessed by an originating secure computer system, transmitted through zero, one, or more intermediary secure computer systems, and received at a storage secure computer system configured to store the data; the sequence of machines from the originating system through the intermediary stems to the storage system is referred to as the “asymmetric encoding path.” Each secure computer system within the asymmetric encoding path can perform one or more chained encoding operations using encoding components (such as token tables, tokenization operations, encryption keys, encryption keys, and the like) unique to that particular secure computer system. Since each chained encoding operation is based on encoding components unique to the particular secure computer system performing the operation, other secure computer systems in the asymmetric encoding path cannot replicate the chained encoding operation, and cannot reverse the operations to obtain the original sensitive data. Such an architecture beneficially prevents a security breach or unauthorized access of one secure computer system from compromising the security of the entire asymmetric encoding operation, since the breached secure computer system does not contain the encoding components used by the other secure computer systems in the asymmetric encoding path.

Asymmetric encoding is implemented using chained encoding made up of a variety of data protection techniques. For instance, each of a plurality of secure computer systems can perform tokenization operations using a different set of token tables. In addition, each of a plurality of secure computer systems can perform a combination of tokenization or encryption operations unique to the secure computer systems. One or more secure computer systems can perform initialization vector data modifications (either alone, or in combination with one or more encryption or tokenization operations). Secure computer system pairs in the asymmetric encoding path can also perform various encryption operations using public and private key pairs. Certain embodiments of chained encoding are described below in greater detail, though it should be noted that chained encoding consisting of any combination of data protection techniques can be implemented according to the principles described herein.

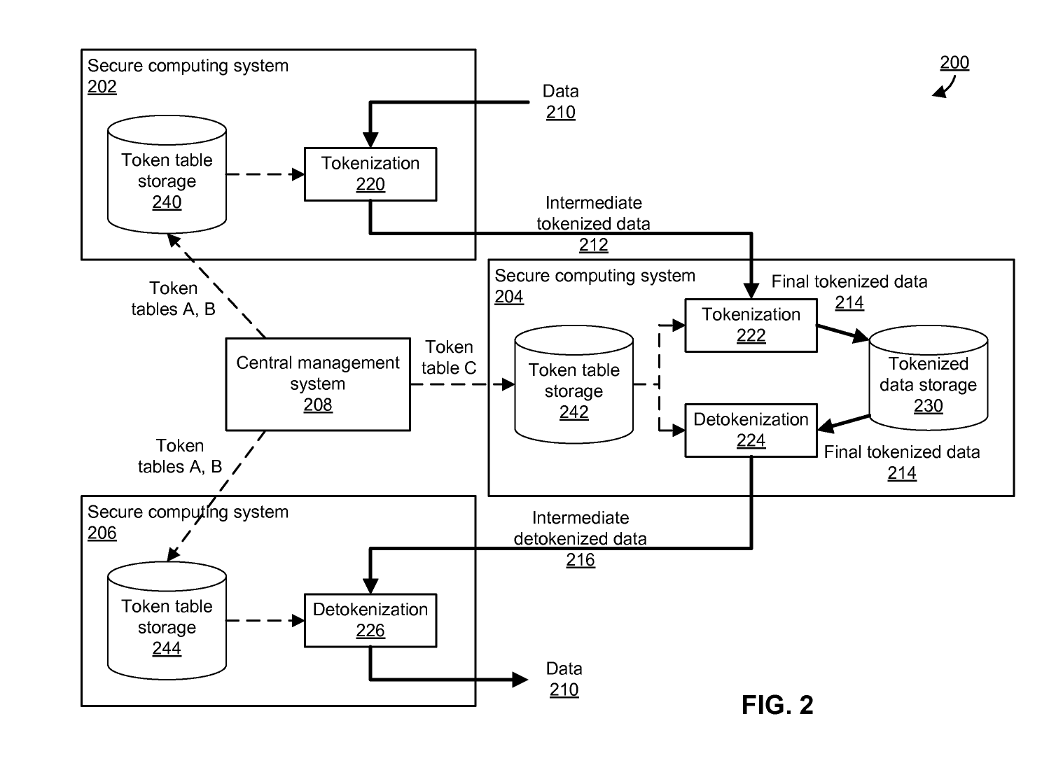

FIG. 2 illustrates data flow in an asymmetric encoding environment 200, according to one embodiment. Data is encoded, transmitted, and decoded at and between a plurality of secure computer systems. The embodiment of FIG. 2 includes secure computer systems 202, 204, and 206 that are each capable of receiving, encoding, and transmitting data. As noted above, the secure computer systems of FIG. 2 are communicatively coupled and can be any computing device, for instance a non-mobile device (e.g., a desktop, server, website, ATM machine, ticket dispenser, other computer, etc.), or a mobile device (e.g., a tablet computer, a laptop, a mobile phone, smart cards, card swipe dongles, etc.). Although only three secure computer systems are illustrated in the embodiment of FIG. 2, other embodiments can include any number of secure computer systems within an asymmetric encoding or decoding chain.

Each secure computer system illustrated in FIG. 2 includes at least a tokenization module and a token table storage module. For instance, secure computer system 202 includes a tokenization module 220 and a token table storage module 240; secure computer system 204 includes a tokenization module 222, a detokenization module 224, and a token table storage module 242; and secure computer system 206 includes a detokenization module 226 and a token table storage module 244. The tokenization modules and detokenization modules are configured to tokenize and detokenize data, respectively. The secure computer system 204 additionally includes a tokenized data storage module 230 configured to store data tokenized by the tokenization module 222. A tokenization module can be implemented by a program executed by a processor, or by hardware logic; storage can be implemented in any non-transitory storage device. The secure computer systems may include additional components not illustrated in FIG. 2 (e.g., network management, authentication, account management, input/output devices) that are not material to the invention. In addition, it should be emphasized that while the secure computer systems of FIG. 2 perform tokenization operations, in other embodiments, the secure computer systems can additional implement data protection techniques, such as encryption, data modification using initialization vectors, and the like.

The secure computer systems of FIG. 2 are coupled to a central management system 208 configured to generate and/or store a plurality of token tables. The central management system selectively distributes the tokenization tables to each secure computer system such that no one secure computer system has access to all token tables used to tokenize or detokenize data. In the embodiment of FIG. 2, the central management system distributes token tables A and B to the secure computer systems 202 and 206 and token table C to the secure computer system 204. In this embodiment, the secure computer system 204 does not have access to token tables A and B, and the secure computer systems 202 and 206 do not have access to token table C. The central management system can add, remove, or update the token tables at each secure computer system. For example, the central management system can generate new token tables (for instance, periodically or in response to an asymmetric encoding operation), and can distribute the new token tables to the secure computer systems (for instance, replacing the token tables A, B, and C).

The central management system 208 can be configured to determine if a secure computer system has been compromised or accessed by an unauthorized entity using one or more intrusion detection techniques. Upon determining that a secure computer system is compromised, the central management system can delete the token tables stored at the compromised secure computer system, can replace them with updated token tables. The central management system can also disable a compromised secure computer system from performing data protection operations in an asymmetric encoding or decoding chain. For example, if three secure computer systems each tokenize data sequentially, and if the second secure computer system is compromised, the central management system can disable the second secure computer system such that the first secure computer system tokenizes data and transmits the tokenized data to the third secure computer system for tokenization. As noted above, the central management system can also generate, store, and distribute encryption keys, initialization vectors, and other encoding components.

The asymmetric encoding environment of FIG. 2 tokenizes and stores data 210 using the secure computer systems 202 and 204. The secure computer system 202 receives the data 210, tokenizes the data into intermediate tokenized data 212, and outputs the intermediate tokenized data to the secure computer system 204. In the embodiment of FIG. 2, the secure computer system 202 tokenizes the received data using the tokenization module 220. The tokenization module 220 access the token tables A and B from the token table storage module 240, and tokenizes the received data by replacing portions of the data with tokens mapped to the values of the data portions within the token tables A and B. As the token tables A and B are not accessible to the secure computer system 204, the intermediate tokenized data cannot be detokenized into the original received data 210 by the secure computer system 204.

The secure computer system 204 receives and tokenizes the intermediate tokenized data 212 into final tokenized data 214. In the embodiment of FIG. 2, the secure computer system 204 tokenizes the intermediate tokenized data using the tokenization module 222. The tokenization module 222 accesses the token table C from the token table storage module 242, and tokenizes the intermediate tokenized data using the token table C to produce the final tokenized data. As the token table C is not accessible to the secure computer systems 202 and 206, neither of these secure computer systems are able to completely detokenize the final tokenized data back into the original received data 210. Upon producing the final tokenized data, the tokenization module 222 stores the final tokenized data in the tokenized data storage module 230.

The asymmetric encoding environment of FIG. 2 detokenizes stored tokenized data using the secure computer systems 204 and 206, for instance, in response to a request for data from the secure computer system 206 or an entity external to the environment of FIG. 2. The secure computer system 204 accesses the final tokenized data 214 from the tokenized data storage module 230, and detokenizes the final tokenized data, producing intermediate detokenized data 216. In the embodiment of FIG. 2, the detokenization module 224 accesses the token table C from the token table storage module 242, and detokenizes the final tokenized data using the token table C. The intermediate detokenized data is received by the secure computer system 206, which detokenizes the intermediate detokenized data, producing the original data 210. In the embodiment of FIG. 2, the detokenization module 226 accesses the token tables A and B from the token table storage module 244, and detokenizes the intermediate detokenized data using the token tables A and B. The secure computer system 206 then outputs the data 210, for instance to an entity that requested the detokenization.

It should be noted that in some embodiments, the intermediate detokenized data 216 is identical to the intermediate tokenized data 212, while in other embodiments, the intermediate detokenized data is different than the intermediate tokenized data. For example, if the central management system 208 distributes the token tables A and B to the secure computer system 202, the token tables C and D to the secure computer system 204, and the token tables A, B, and C to the secure computer system 206, the initial data 210 tokenizes the secure computer system 202 using token tables A and B, producing the intermediate tokenized data 212. Continuing with this example, the secure computer system 204 tokenizes the intermediate tokenized data using the token tables C and D, producing final tokenized data 214. The secure computer system 204 can then detokenize the final tokenized data using only the token table D, producing the intermediate detokenized data 216, and the secure computer system 206 can detokenize the intermediate detokenized data using the token tables A, B, and C, producing the original by the secure computer system 104. In this example, the intermediate tokenized data is different from the intermediate detokenized data.

In one embodiment, the asymmetric environment of FIG. 2 performs chained tokenization operations in response to receiving the data 210, in response to a request from a user of the secure computer systems 202 or 204, or in response to any other event. Similarly, the environment of FIG. 2 can perform chain detokenization operations in response to receiving a request from the secure computer system 204 or 206 (for instance, in response to an automated request from the secure computer systems or a request from a user of either secure computer system), or in response to any other event. In one example embodiment, the secure computer system 202 is an ATM terminal or banking application on a mobile phone, the secure computer system 204 is a bank server system, and the secure computer system 206 is a bank teller's computer.

The asymmetric encoding of FIG. 2 is performed with secure computer systems 202 and 204. However, it should be noted that asymmetric encoding can also be implemented using a greater number of secure computer systems. In addition, while the asymmetric decoding of FIG. 2 is performed with two secure computer systems, secure computer systems 204 and 206, asymmetric encoding can also be implemented using a greater number of secure computer systems. In some embodiments, an asymmetric encoding environment can implement asymmetric encoding and decoding using a different number of secure computer systems (for instance, 5 secure computer systems can be used for encoding and 3 secure computer systems can be used for decoding). It should also be noted that although the secure computer system 204 is configured to perform both tokenization and detokenization, in other embodiments, tokenization and detokenization operations are performed by different secure computer systems. Further, although the final tokenized data 214 is stored within the secure computer system 204 in the embodiment of FIG. 2, in other embodiments, the final tokenized data is stored external to the secure computer systems of the asymmetric encoding environment.

In some embodiments, the token tables provided by the central management system 208 to the token table storage 240, 242, and 244 are one-way token tables and cannot be used both for tokenization and detokenization. In such embodiments, for each token table provided by the central management system 208 to a secure computer system that performs tokenization operations, a reciprocal token table is provided to a secure computer system that performs detokenization operations. Further, as discussed above, any number of secure computer systems can be implemented in the environment of FIG. 2, and each secure computer system can use any number of token tables in performing any number of tokenization or detokenization operations, so long as no single secure computer system can access a set of token tables that can be used to completely tokenize the data 210 or detokenize the final tokenized data 214.

Allocating chained tokenization operations across secure computer systems such that no one secure computer system can completely tokenize or detokenize data beneficially prevents a compromise of one secure computer system from completely compromising the asymmetric encoding environment of FIG. 2. Allocating chained tokenization operations across secure computer systems further reduces the storage and processing requirements of each secure computer system in the environment of FIG. 2. For instance, certain token tables may be too large to store in some secure computer system devices, such as mobile devices, smart cards, and card swipe dongles. By allocating various encoding and decoding operations between different secure computer systems, smaller token tables can be located/stored at each secure computer system while maintaining the level of security of a single secure computer system with a larger token table.

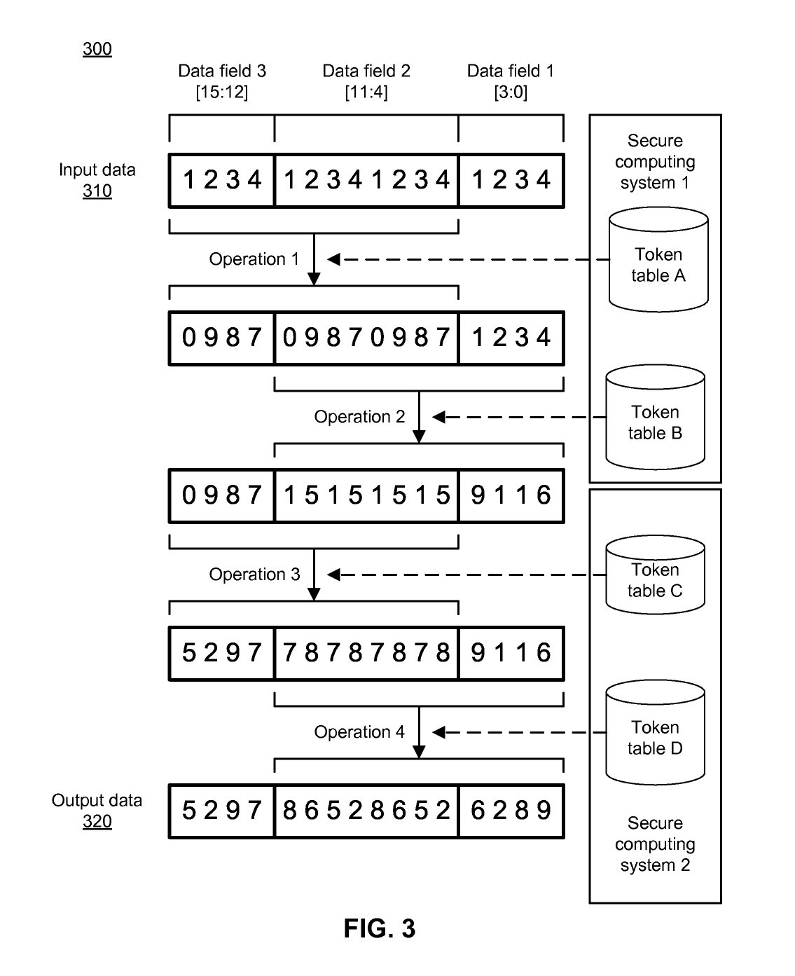

FIGS. 3-5 illustrate example chained asymmetric encoding operations, according to one embodiment. As noted above, chained encoding can include combinations of various encoding and decoding operations, such as tokenization, de-tokenization, encryption, decryption, data modification, data de-modification, and the like. Each secure computer system in an asymmetric encoding environment can perform a different subset or combination of encoding operations, and any number of secure computer systems can be implemented in the encoding or decoding of data. As noted above, embodiments of asymmetric encoding can include different types, numbers, or sequences of encoding operations that can be distributed across different secure computer systems such that no one secure computer system is able to fully encode or decode data.

FIG. 3 illustrates an example implementation 300 of chained tokenization including four tokenization operations. Each tokenization operation is performed by a secure computer system, and various embodiments can include tokenization operations of different portions of data and performed on different combinations of secure computer systems. In one embodiment, the number of tokenization operations performed by a secure computer system and/or the number of token tables available to a secure computer system for use in tokenization is based on a security level associated with the secure computer system. It should be noted that although FIG. 3 describes tokenization operations, other operations can be implemented, such as detokenization operations, encryption or decryption operations, or any other suitable encoding operation.

In FIG. 3, input data 310 is a 16-byte data string, “1234123412341234,” and is segmented into three data fields: data field 1, consisting of the first four bytes “1234”, data field 2, consisting of the middle eight bytes “12341234”, and data field 3, consisting the last four bytes “1234.” During each tokenization operation, a portion of the data is used by a secure computer system to query a token table, and a token mapped to the value of the queried data portion is used to replace the queried data portion. In operation 1, data fields 2 and 3 are tokenized by secure computer system 1 using token table A. The token “0987” is mapped to the value “1234”, and thus each 4-bit value of data fields 2 and 3 equal to the value “1234” are replaced with the token “0987”. Data field 1, not involved in the tokenization operation, remains the same during operation 1.

In operation 2, data fields 1 and 2 are tokenized by the secure computer system 1 using the token table B, which is different from token table A. During this operation, the sequences “0987” and “1234” are used to query the token table B, and are replaced by the tokens “1515” and “9116” (mapped to the values “0987” and “1234” in the token table B), respectively. Note that while token table A maps the token “0987” to the value “1234”, token table B maps the token “9116” to the value “1234”. In operation 3, the data fields 2 and 3 are tokenized by the secure computer system 2 using the token table C, which is different from both token table A and token table B. During operation 3, the value “0987” is replaced by the token “5297” (which is mapped to the value “0987” by the token table C), and the values “1515” are replaced by the values “7878” (which is mapped to the value “1515” by the token table C). Finally, in operation 4, data fields 1 and 2 are tokenized by the secure computer system 2 using the token table D, which is different from token tables A, B, and C. Thus the sequences “7878” and “9116” are replaced with “8652” and “6289”, respectively. The final tokenized output data 320 is the 16-byte sequence “5297865286526289”.

In other embodiments, the data may be segmented into other data field organizations prior to and during the asymmetric encoding. Further, in some embodiments, tokenization operations are performed on a different selection of data fields than illustrated in FIG. 3. For example, some tokenization operations may tokenize only one data field while others may tokenize all data fields. In other embodiments, different token tables or different combinations of token tables can be used in each operation. For example, operation 1 can use a combination of token tables A and B to tokenize data, operations 2 and 3 can use token table B to tokenize data, and operation 4 can use token tables A, C, and D to tokenize data. In other embodiments, different numbers or types of encoding operations are implemented, and additional layers of security can be provided by increasing the number of encoding operations, distributing the operations among a greater number of secure computer systems, using additional token tables, and so forth.

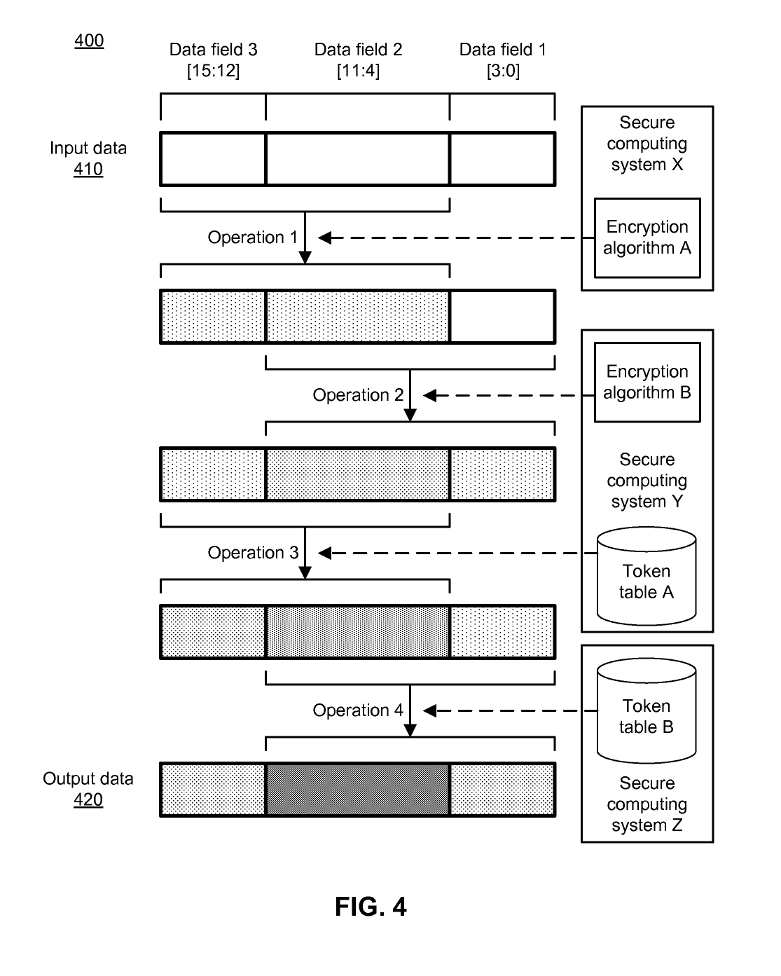

In addition to tokenization, other encoding operations can be performed in an asymmetric encoding environment. The embodiment 400 of FIG. 4 is similar to the embodiment of FIG. 3 in that the input data 410 is 16-bytes wide and organized into three data fields: data field 1, consisting of the first four bytes of the input data, data field 2, consisting of the middle 8 bytes of the input data, and data field 3, consisting of the last four bytes of the input data. In addition, the embodiment of FIG. 4 includes four encoding operations (two encryption operations and two tokenization operations). As described above, other embodiments of asymmetric encoding can include a different number, order, and combination of encoding operations than the embodiment of FIG. 4, and the input data can be any length and divided into any data field organization, both before and during encoding. As with the embodiment of FIG. 3, the operations described herein operations are performed by at least two different secure computer systems. In the embodiment of FIG. 4, operation 1 is performed by secure computer system X, operations 2 and 3 are performed by secure computer system Y, and operation 4 is performed by secure computer system Z.

Operations 1 and 2 are encryption operations and operations 3 and 4 are tokenization operations. During each operation, a portion of the data is received by a secure computer system, encoded, and outputted as encoded data. During operation 1, an encryption algorithm A is used by secure computer system X to encrypt the data in data fields 2 and 3. During operation 2, an encryption algorithm B, distinct from the encryption algorithm A, is used by secure computer system Y to encrypt the data in data fields 1 and 2. The encryption algorithms can be any encryption algorithms, such as one-way or asymmetric encryption. During operations 3 and 4, token tables A and B, respectively, are used to tokenize various portions of the data. The token tables A and B can be different from each other (for instance, by mapping at least one value to different tokens). It should be noted that any number or order of encryption and tokenization operations can be performed in an asymmetric encoding environment, and any combination of secure computer systems can be used in encoding data. So long as no single secure computer system has access to both the encryption algorithms A and B and the token tables A and B, no secure computer system can fully encode the input data 410 into the output data 420.

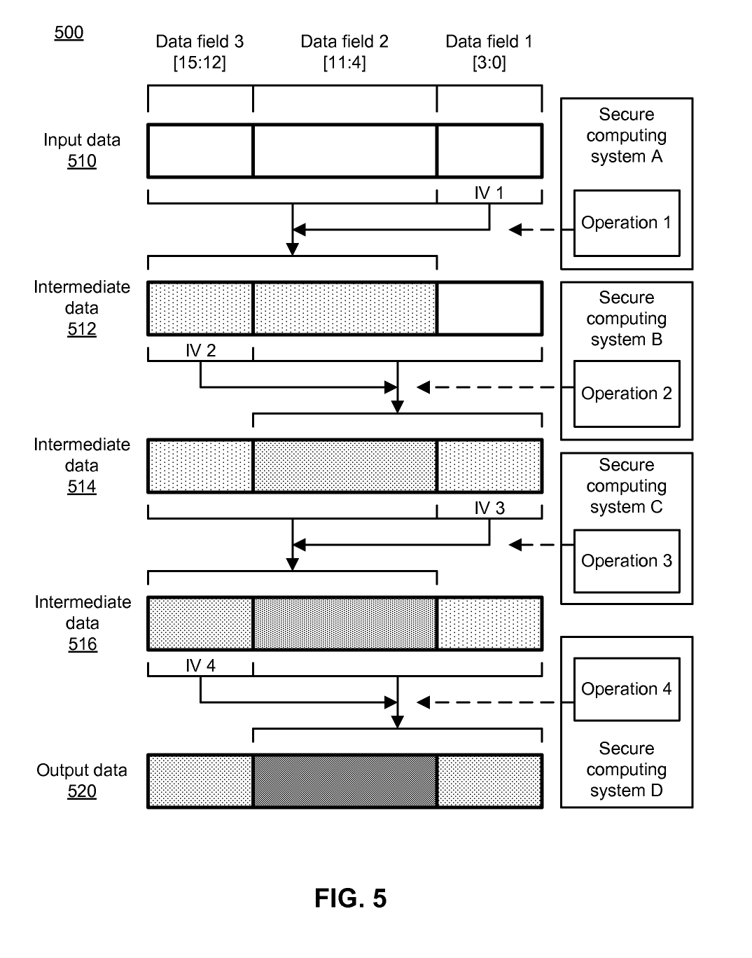

FIG. 5 illustrates an embodiment 500 of asymmetric encoding with four different secure computer systems, each configured to modify a portion of data using IVs and to perform one or more encoding operations (e.g., encryption, tokenization, and the like) on the modified data. The IVs of FIG. 5 are based on the intermediate data produced by each secure computer system after the secure computer system performs an encoding operation. In other embodiments, the IVs can be based on other factors, for instance the value of the input data 510, an identity of a user of the asymmetric encoding environment, based on parameters associated with the encoding operations illustrated in FIG. 5, or based on any other suitable factors. Since each secure computer system uses a different IV to modify the data, and since no one secure computer system has access to all IVs, no single secure computer system can entirely encode or decode data.

In the embodiment of FIG. 5, secure computer system A uses data field 1 of the input data 510 as an initialization vector (IV 1) for modifying data fields 2 and 3 of the input data, and performs an encoding operation on modified data fields 1 and 2, creating intermediate data 512. Secure computer system B then uses data field 3 of the intermediate data 512 as IV 2 for modifying data fields 2 and 3 of the intermediate data 512, and performs an encoding operation on the modified data fields 2 and 3 of the intermediate data 512, creating intermediate data 514. This process is continued by secure computer system C for operation 3 (data field 3 of intermediate data 514 is used as IV 3) to produce intermediate data 516, and at secure computer system D for operation 4 (data field 1 of intermediate data 516 is used as IV 4) to produce output data 520.

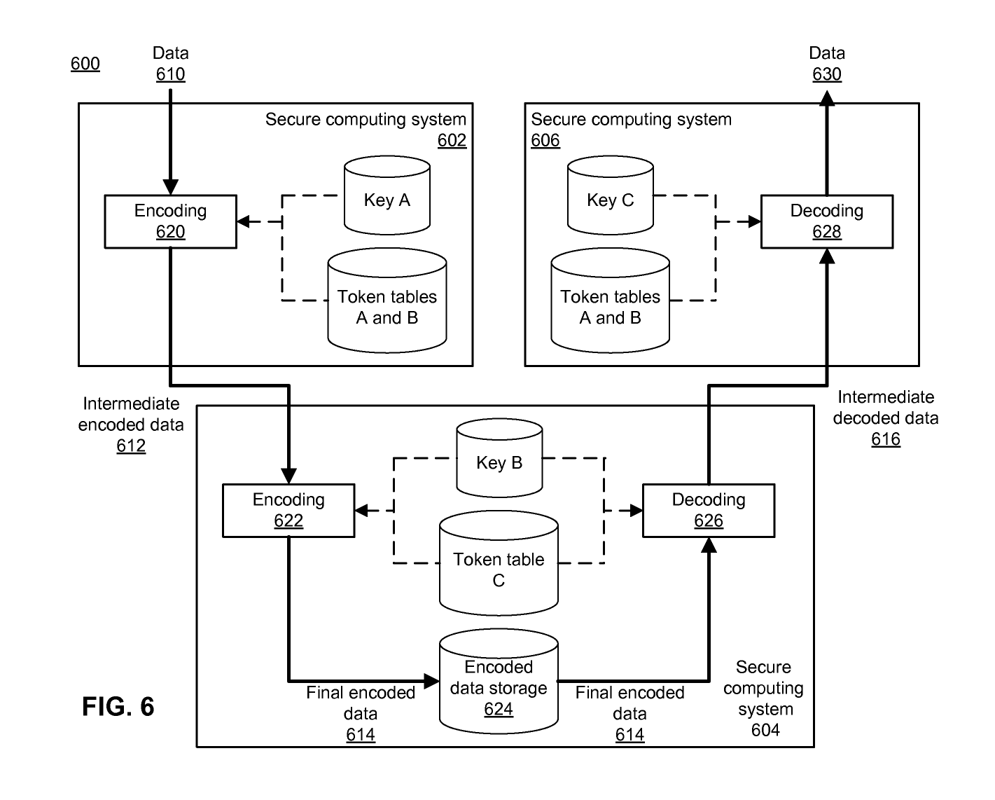

As shown in FIGS. 4 and 5, secure computer systems can perform a combination of tokenization and encryption when encoding data in an asymmetric encoding environment. FIG. 6 illustrates such a data flow in an asymmetric encoding environment, according to one embodiment. The environment of FIG. 6 includes secure computer systems 602, 602, and 606, each including storage modules for storing one or more token tables and one or more encryption keys. It should be noted that instead of storing token tables and encryption keys, the secure computer systems can instead generate or access the token tables and encryption keys from an external source. Not illustrated in the embodiment of FIG. 6 is a central management system configured to manage distribution of token tables and encryption keys, though it should be noted that some embodiments can include a central management system. In the embodiment of FIG. 6, the secure computer system 602 stores the encryption key A and the token tables A and B, the secure computer system 604 stores the encryption key B and the token table C, and the secure computer system 606 stores the encryption key C and the token tables A and B.

The secure computer system 602 includes an encoding module 620 configured to perform one or more tokenization operations and encryption operations on received data to produce intermediate encoded data 612. Upon receiving the data 610, the encoding module encrypts the data using the encryption key A and tokenizes the data using the token tables A and B. The encoding module can perform any order or combination of tokenization and encryption operations. For instance, the encoding module can tokenize the data using token table A to produce first tokenized data, can encrypt the first tokenized data using the encryption key A to produce first encrypted data, and can tokenize the first encrypted data using token table B to produce the intermediate encoded data.

The secure computer system 604 includes an encoding module 622 configured to receive the intermediate encoded data 612 and perform one or more tokenization operations and encryption operations on the intermediate encoded data to produce the final encoded data 614. The encoding module can perform any order or combination of tokenization and encryption operations using the token table C and the encryption key B, respectively. The final encoded data is stored in the encoded data storage module 624. The secure computer system 604 also includes a decoding module 626 configured to access the final encoded data from the encoded data storage module and to perform one or more decryption and detokenization operations on the final encoded data using the encryption key B and the token table C, respectively, to produce the intermediate decoded data 616.

The secure computer system 606 includes a decoding module 628 configured to receive the intermediate decoded data 616 and to perform some combination of decryption and detokenization operations using the encryption key C and the token tables A and B, respectively, producing the data 630. As none of the secure computer systems have access to all of the token tables and the encryption keys used in the asymmetric encoding environment of FIG. 6, no single secure computer system can fully encode or decode data. For instance, as the secure computer system 604 does not have access to the encryption key A and the token tables A and B, it cannot fully decode the received intermediate encoded data. Accordingly, if one of the secure computer systems is compromised by an unauthorized entity, the unauthorized entity is prevented from being able to fully encode or decode data, beneficially enhancing the security of such an asymmetric encoding environment.

In an example embodiment of FIG. 6, the secure computer systems 602, 604, and 606 are a smartphone, an online shopping website, and a credit card company, respectively. A user can enter credit card information into a smartphone (secure computer system 602). The credit card information can be encoded by the smartphone using the encryption key A and the token tables A and B. The encoded data is transferred through the Internet to the online shopping website's servers (secure computer system 604), where it is further encoded with the encryption key B and the token table C, and stored. By storing the credit card information, the online shopping website can securely use the credit card information to allow for future user purchases without having to prompt the user to enter the information again. The online shopping website decodes the stored credit card information with token table C and the encryption key B before transmitting the credit card information to the credit card company (secure computer system 606). The credit card company decodes the credit card information with token tables A and B and encryption key C, allowing the credit card company to charge the user's account associated with the credit card for the purchase. Other examples of asymmetric encoding environments can include ATMs and banks, computers and secured websites, payment devices and payment companies, and so forth.

It should be noted that various combinations of public/private encryption keys can be used at different secure computer systems of the embodiment of FIG. 6 to enhance security and to allow for one-way encoding. Such one-way encoding utilizes asymmetric encryption to increase security, since a secure computer system that encrypts data with a first key during encoding is unable to decode the data without a second, complementary key. The secure computer system 606 can maintain a first private key (such as encryption key C) and can distribute a public key associated with the first private key to secure computer system 602 (such as encryption key A). Similarly, the secure computer system 606 can distribute a public key associated with a private encryption key D (not illustrated in FIG. 6) to the secure computer system 604 (for instance, encryption key B). Data encrypted with the public encryption keys A and B can only be decrypted with the private keys C and D. Accordingly, access to a secure computer system with access to only a public key or a private key by an unauthorized entity will not enable the unauthorized entity from being able to fully encrypt or decrypt data within the dataflow of FIG. 6. It should be noted that in some embodiments, the secure computer system 604 can maintain a first private key and can provide a corresponding first public key to the secure computer system 602 for use in encoding and decoding, and the secure computer system 606 can maintain a second private key and can provide a corresponding second public key to the secure computer system 604 for use in encoding and decoding.

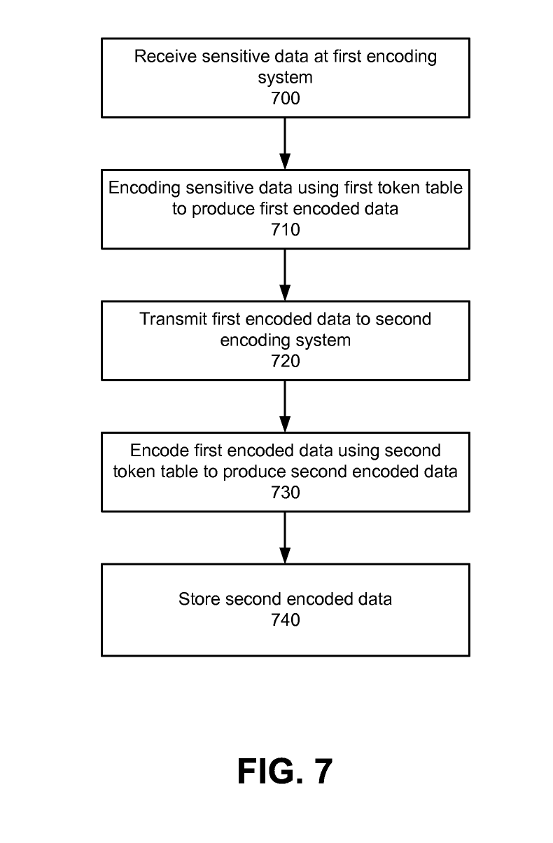

FIG. 7 illustrates a process for encoding data using asymmetric encoding, according to one embodiment. Sensitive data is received 700 at a first encoding system. The first encoding system encodes 710 the sensitive data using a first token table to produce first encoded data, and transmits 720 the first encoded data to a second encoding system. The second encoding system encodes 730 the first encoded data using a second token table to produce second encoded data, and stores 740 the second encoded data. The first encoding system does not have access to the second token table, and the second encoding system does not have access to the first token table, preventing either encoding system from being able to fully encode the received data or decode the second encoded data. It should be noted in some embodiments, the encoding systems can implement additional data protection techniques, such as encryption, data modification using initialization vectors, and the like.

### Additional Configuration Considerations

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determine” refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a non-transitory computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method for asymmetric encoding comprising:
receiving, at a first secure computing system, sensitive data to be encoded;
encoding, by the first secure computer system, the received sensitive data to produce first encoded data, wherein the first secure computer system is configured to:
encrypt data using a first encryption key; and
tokenize data using a first token table;
receiving, at a second secure computing system, the first encoded data;
encoding, by the second secure computer system, the first encoded data to produce second encoded data, wherein the second secure computer system is configured to:
encrypt data using a second encryption key; and
tokenize data using a second token table, wherein the first secure computer system does not have access to the second encryption key and the second token table and wherein the second secure computer system does not have access to the first encryption key and the first encryption table; and
storing the second encoded data.

2. The computer-implemented method of claim 1, wherein a central management system communicatively coupled to the first secure computer system and the second secure computer system provides the first secure computer system access to the first encryption key and the first token table, and provides the second secure computer system access to the second encryption key and the second token table.

3. The computer-implemented method of claim 1, further comprising:
decoding, by the second secure computer system, the second encoded data to produce first decoded data, wherein the second secure computer system is further configured to:
decrypt data using the second encryption key; and
detokenize data using the second token table; and
decoding, by a third secure computer system, the first decoded data to produce second decoded data, wherein the third secure computer system is configured to:
decrypt data using a third encryption key; and
detokenize data using the first token table.

4. The computer-implemented method of claim 3, wherein the third encryption key comprises a private key, wherein the first encryption key comprises a public key corresponding to the private key, and wherein the third secure computer system is configured to generate the public key and private pair and to provide the public key to the first secure computer system as the first encryption key.

5. The computer-implemented method of claim 4, wherein the third secure computer system is configured to generate the public key and private key and to provide the public key to the first secure computer system in response to a request by the first secure computer system.

6. The computer-implemented method of claim 1, wherein encoding comprises:
encrypting one of the received sensitive data or the first encoded data to form encrypted data; and
tokenizing the encrypted data.

7. The computer-implemented method of claim 1, wherein encoding comprises:
tokenizing one of the received sensitive data or the first encoded data to form tokenized data; and
encrypted the tokenized data.

8. A system for asymmetric encoding comprising:
an input configured to receive sensitive data to be encoded;
a first secure computer system configured to encode the received sensitive data to produce first encoded data, wherein the first secure computer system is additionally configured to:
encrypt data using a first encryption key; and
tokenize data using a first token table;
a second secure computer system configured to encode the first encoded data to produce second encoded data, wherein the second secure computer system is additionally configured to:
encrypt data using a second encryption key; and
tokenize data using a second token table; and
a memory configured to store second encoded data;
wherein the first secure computer system does not have access to the second encryption key and the second token table, and wherein the second secure computer system does not have access to the first encryption key and the first encryption table.

9. The system of claim 8, further comprising:
a central management system communicatively coupled to the first secure computer system and the second secure computer system configured to provide the first secure computer system access to the first encryption key and the first token table, and to provide the second secure computer system access to the second encryption key and the second token table.

10. The system of claim 8, wherein the second secure computer system is further configured to decode the second encoded data to produce first decoded data using the second encryption key and the second token table, and further comprising:
a third secure computer system configured to decode the first decoded data to produce second decoded data, wherein the third secure computer system is additionally configured to:
decrypt data using a third encryption key; and
detokenize data using the first token table.

11. The system of claim 10, wherein the third encryption key comprises a private key, wherein the first encryption key comprises a public key corresponding to the private key, and wherein the third secure computer system is further configured to generate the public key and private pair and to provide the public key to the first secure computer system.

12. The system of claim 11, wherein the third secure computer system is configured to generate the public key and private key paid and to provide the public key to the first secure computer system in response to a request by the first secure computer system.

13. The system of claim 8, wherein encoding comprises:
encrypting one of the received sensitive data or the first encoded data to form encrypted data; and
tokenizing the encrypted data.

14. The system of claim 8, wherein encoding comprises:
tokenizing one of the received sensitive data or the first encoded data to form tokenized data; and
encrypted the tokenized data.

15. A computer-implemented method for asymmetric encoding comprising:
receiving sensitive data to be encoded;
providing a first secure computer system access to a first token table;
providing a second secure computer system access to a second token table;
tokenizing, by the first secure computer system, a portion of the input data with the first token table to produce first tokenized data, wherein the first secure computer system does not have access to the second token table;
tokenizing, by the second secure computer system, a portion of the first tokenized data with the second token table to produce second tokenized data, wherein the second secure computer system does not have access to the first token table; and
storing the second tokenized data.

16. The computer-implemented method of claim 1, wherein access to the first token table and the second token table is provided by a token server communicatively coupled to the first secure computer system and the second secure computer system.

17. The computer-implemented method of claim 16, wherein the token server is configured to store the first token table and the second token table at the first secure computer system and the second secure computer system, respectively.

18. The computer-implemented method of claim 16, wherein the token server is configured to prevent the first secure computer system from having access to the second token table and to prevent the second secure computer system from having access to the first token table.

19. The computer-implemented method of claim 15, further comprising:
detecting a security compromise at one of the first secure computer system and the second secure computer system; and
providing the compromised secure computer system with access to an updated token table.

20. The computer-implemented method of claim 15, further comprising:
before tokenizing a portion of the input data, modifying, by the first secure computer system, the input data using a first initialization vector to form first modified data;
tokenizing, by the first secure computer system, the first modified data with the first token table to produce first tokenized data; and
before tokenizing a portion of the first tokenized data, modifying, by the second secure computer system, the first tokenized data using a second initialization vector different from the first initialization vector to form second modified data; and
tokenizing, by the second secure computer system, the second modified data with the second tokent able to produce second tokenized data.
